(19) United States
(12) Patent Application Publication
(10) Pub. No.: US 2022/0282640 A1
(43) Pub. Date: Sep. 8, 2022

(54) SYSTEM FOR CONVERTING THERMAL ENERGY INTO MECHANICAL WORK

(71) Applicant: Siemens Energy Global GmbH & Co. KG, Munich, Bayern (DE)

(72) Inventors: Stefan Glos, Recklinghausen (DE); Stefanie Grotkamp, Mülheim (DE); Robin Sudhoff, Essen (DE); Michael Wechsung, Mülheim an der Ruhr (DE)

(73) Assignee: Siemens Energy Global GmbH & Co. KG, Munich, Bayern (DE)

(21) Appl. No.: 17/625,745

(22) PCT Filed: Jun. 25, 2020
(86) PCT No.: PCT/EP2020/067830

§ 371 Date: Jan. 8, 2022

(30) Foreign Application Priority Data
Jul. 19, 2019 (DE) 10 2019 210 680.3

(51) Int. Cl. F01K 25/10; F01K 9/00

(52) U.S. Cl. CPC F01K 25/103; F01K 9/003

(57) ABSTRACT

A system includes a pump for conveying a flow medium, an arrangement for converting the flow medium from a liquid state into a gaseous state, a turbomachine for converting the thermal energy of the flow medium into mechanical work, a condenser for condensing the gaseous flow medium into a liquid state, with a cooling unit for cooling the liquid flow medium being arranged upstream of the pump in order to reduce the compression work.

### CROSS REFERENCE TO RELATED APPLICATIONS

This application is the US National Stage of International Application No. PCT/EP2020/067830 filed 25 Jun. 2020, and claims the benefit thereof. The International Application claims the benefit of German Application No. DE 10 2019 210 680.3 filed 19 Jul. 2019. All of the applications are incorporated by reference herein in their entirety.

### FIELD OF INVENTION

The invention relates to a system comprising a pump for conveying a flow medium, an arrangement for converting the flow medium from a liquid state to a gaseous state, a flow machine for converting the thermal energy of the flow medium to mechanical energy, a condenser for condensing the gaseous flow medium to a liquid state.

### BACKGROUND OF INVENTION

Combined heat and power processes can be implemented in a closed manner. One example of a closed combined heat and power process is a water-steam circuit in a power plant for generation of electrical energy. This uses water/steam as heat carrier and working medium. Such cycle processes are known by the name “Clausius-Rankine process”.

At low process temperatures, these cycle processes are also operated with organic flow media. Such cycle processes are known by the name “organic Rankine cycle”.

Even though the flow medium in an organic Rankine cycle, strictly speaking, is not pure steam, the flow machines used in these cycle processes for conversion of the thermal energy to mechanical energy are referred to as steam turbines. Another term for a flow machine operated with CO₂ as flow medium would be CO₂ expander.

A further flow medium that can be used in a cycle is carbon dioxide. One advantage of carbon dioxide over water is that the critical point is at a comparatively low pressure and temperature level. The critical point of carbon dioxide is at a pressure of about 74 bar and a temperature of about 31° C. The critical point of water, by comparison, is at a pressure of about 221 bar and a temperature of 385° C. Such cycles are almost always supercritical cycles. Therefore, such cycles are also referred to as supercritical carbon dioxide cycles or sCO₂ cycles (sCO₂=supercritical CO₂). Even though the flow medium here too is not steam, the flow machine used for the conversion of thermal energy to mechanical energy is called a steam turbine.

FIG. 1 shows a cycle 1 according to the prior art in a CO₂ cycle process. Prior to entry 2 into the pump 3, the flow medium (CO₂) is converted from the gaseous state to a liquid state in a condenser 4. The pump 3 conveys the liquid CO₂ to an arrangement 5 designed for conversion of liquid CO₂ to gaseous CO₂. This is effected using fuels, for example fossil fuels, or else by the use of geothermal heat, which is known by the term “geothermal power plant”. Downstream of the arrangement 5, the gaseous CO₂ flows to a steam turbine (6) designed for conversion of the thermal energy from the CO₂ to mechanical energy. Subsequently, the cooled CO₂ arrives at the condenser 4, which completes the circuit.

An essential feature of such sCO₂ cycles is that the flow medium is compressed in the near-liquid state region. This means that the working medium has compressible properties. This contrasts with a Clausius-Rankine process, in which water as flow medium can be described as incompressible. This means that the compressor or pump has to perform a comparatively large amount of compression work.

Since compressions are associated with losses, this means that a low level of compression work, as in a steam cycle, leads to low losses, and a high level of compression work, as in sCO₂ cycles, leads to large losses.

U.S. Pat. No. 8,316,955 B2 discloses a use of sCO₂ cycles for geothermal power generation. The system described therein has an additional principle of action on account of the significant difference in geodetic height. The supply of heat takes place in the ground, specifically at depths of more than 730 m and frequently at depths of 2000 m to 5000 m. There is a distinct difference here in the average density of “cold” CO₂ (at 10° C. to 40° C.) along the injection well from the average density of hot CO₂ (between about 60° C. and 260° C.). This difference in density gives rise to a natural circulation of the flow medium, which is also referred to as the thermosiphon effect. The working medium circulates without addition of mechanical work. The drawing of thermal energy from the ground can be accelerated with a circulation pump.

For these geothermal cycles too, it is important to cool down the cold flow medium as far as possible in the liquid direction, since this decreases the density at the inlet of the injection well and the compressibility of the flow medium, and hence reduces the necessary compression work on entry thereof. The thermosiphon effect is thus enhanced.

### SUMMARY OF INVENTION

It is an object of the invention to improve a system having an sCO₂ cycle.

This object is achieved by a system comprising a pump for conveying a flow medium, an arrangement for converting the flow medium from a liquid state to a gaseous state, a flow machine for converting the thermal energy of the flow medium to mechanical energy, a condenser for condensing the gaseous flow medium to a liquid state, wherein the system has a cooling unit for cooling the liquid flow medium.

The object is also achieved by a method of operating a system, in which a flow medium in the liquid state is conveyed with a pump to an arrangement, wherein the flow medium is converted from a liquid state to a gaseous state in the arrangement, wherein the gaseous flow medium is guided into a flow machine, where the thermal energy of the flow medium is converted to mechanical energy, wherein, downstream of the flow machine, the flow medium is converted back to the liquid state in a condenser, wherein, downstream of the condenser, the temperature of the flow medium is reduced with a cooling unit before the flow medium is guided back to the pump.

Advantageous developments are specified in the subsidiary claims.

An essential feature of the invention is the cooling of the flow medium after condensation and before entry into the pump. In other words: the flow medium is subcooled in a controlled manner after the condensation, which distinctly increases density and distinctly reduces compressibility. To put it more accurately: according to the invention, the flow medium is cooled down upstream of the pump or upstream of the first compressor stage with the aim of minimizing compressor work. In addition, staged cooling of the flow medium in the pump or in the compressor may take place, which is known by the term “intercooling” or “interstage cooling”.

If the cooling is effected with an apparatus in which a cooling water is used, the aim is to cool down the flow medium such that the temperature of the flow medium gets as close as possible to the temperature of the cooling medium.

One advantage of the invention is that the physical properties of CO₂ enhance the thermosiphon effect when the system of the invention is used in a geothermal power plant.

In an advantageous development, the cooling unit is designed as a heat exchanger. Another term for the cooling unit would be “subcooler”. The cooling should advantageously be designed such that the reduction in temperature of the flow medium after condensation is 5 K. The reduction in temperature may also be higher or lower than 5 K.

In a further advantageous development, the further cooling unit is designed as a heat exchanger. A further term for the further cooling unit would be “desuperheater”.

The flow machine is designed as a steam turbine or CO₂ expander, or may be referred to as steam turbine or CO₂ expander.

The above-described properties, features and advantages of this invention and the manner in which they are achieved will be elucidated in detail and more clearly and distinctly comprehensibly in association with the drawing.

Working examples of the invention are described hereinafter with reference to the drawings. These are not supposed to show the working example to scale; instead, the drawings, where useful for illustration, are in schematized and/or slightly distorted form. With regard to supplementations of the teachings that are immediately apparent in the drawings, reference is made to the relevant prior art.

Identical parts or components, or parts or components having the same function, are given the same reference numerals.

### BRIEF DESCRIPTION OF THE DRAWINGS

The figures show:

FIG. 1 a cycle according to the prior art.

FIG. 2 a cycle of the invention.

FIG. 3 an arrangement of the invention.

FIG. 4 a representation of a T-S diagram.

### DETAILED DESCRIPTION OF INVENTION

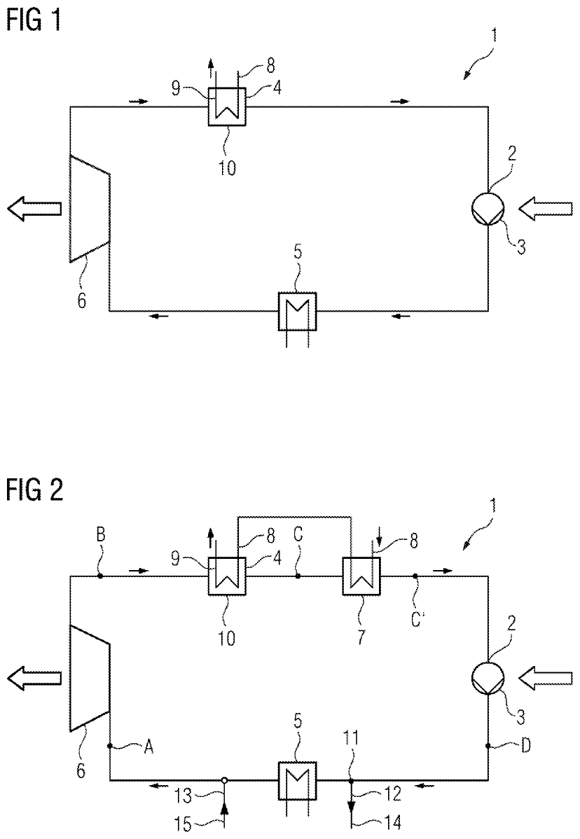

FIG. 1 shows a conventional cycle (1) that has already been described further up.

FIG. 2 shows an inventive cycle 1. The difference between the cycle shown in FIG. 1 and the inventive cycle 1 shown in FIG. 2 is as follows: a cooling unit 7 is disposed between the condenser 4 and the pump 3. The condenser 4 is operated with cooling water 8, against which the cooling medium condenses. The cooling water 8 flows through pipes 9 in a condenser housing 10.

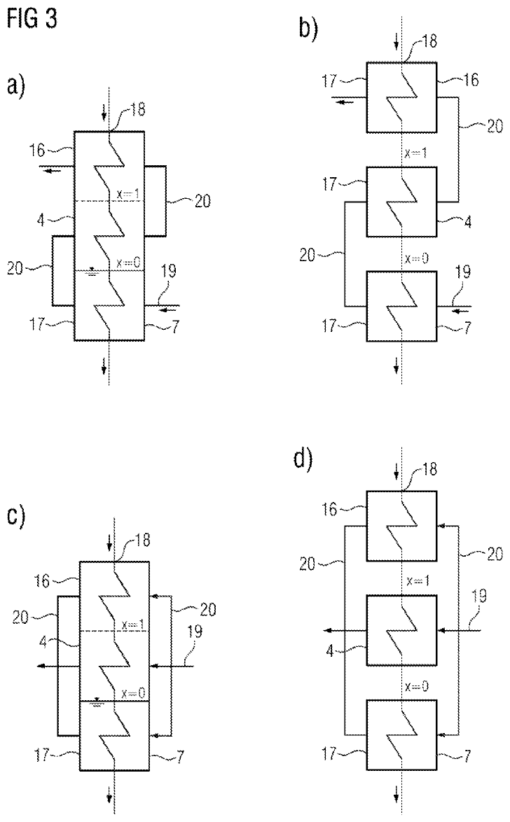

The cooling unit 7 is designed to further cool the liquid flow medium. In one embodiment, the liquid flow medium is operated with cooling water 8. There is a more detailed description of the cooling arrangement 7 in the description for FIG. 3.

The flow medium is CO₂, especially sCO₂.

The cycle shown in FIG. 2 may be used in a geothermal application. For this purpose, no separate component is inserted into the generator 5, but rather the geothermal heat present in the deep strata of the Earth is used. At a first site 11 in the circuit 1 upstream of the original generator 5, a conduit 12 into an underground reservoir (not shown) is formed. The essentially cold flow medium in the reservoir is heated by geothermal heat to such an extent that the flow medium undergoes a phase change from the liquid state to a gaseous state. Subsequently, the gaseous flow medium passes via a feed 13 back into the circuit at the Earth's surface, with the flow medium being guided to the steam turbine 6. Even though the steam turbine 6 as an embodiment of a flow machine is, strictly speaking, operated not with steam but with CO₂, especially sCO₂, reference is made here to steam turbine 6 or CO₂ expander. The steam turbine 6 or CO₂ expander converts the thermal energy of the flow medium to mechanical energy, which can drive a generator, which in turn generates electrical energy.

The arrangement of the invention makes it possible to lower the temperature of the liquid flow medium with the aid of the cooling unit 7 by about 5° C. This results in a relatively strong natural circulation that is referred to as thermosiphon effect, which is characterized by a relatively large difference between the average density of the injection well 14 and that of the production well (15).

The relatively strong thermosiphon effect, with equal circulating mass flow rate, results in a decrease in compression work, or, with equal power consumption by the pump 3, in delivery of a greater mass flow rate. Thus, an increase in net output is achieved.

The possible increase in power, or in other words the net power increase (for fresh water cooling here), is plotted as a function of the cooling water temperature or of the resulting condensation temperature and the reservoir depth. The smaller the difference between the condensation temperature and the critical temperature, the greater the rise in power by virtue of a subcooling device, such as the cooling unit 7. The density of the flow medium increases as a result of the subcooling. An increase in the density on the injection side (injection well 14) leads to greater natural circulation of the flow medium or to substitution of pump power.

The lower the reservoir depth, the greater the rise in power by means of the cooling unit 7. In the case of reservoirs at low depth, the thermosiphon effect, on account of the reservoir pressure and reservoir temperature, is weaker than in the case of reservoirs at greater depth. If the cooling of the liquid flow medium improves the thermosiphon effect by the same absolute magnitude for both reservoirs, this therefore has a greater effect on the relative net power gain in the case of reservoirs at lower depth.

For non-geothermally heated sCO₂ circuits, cooling of the flow medium with the cooling unit 7 is advantageous. In such a circuit 1, the compression of the medium before the supply of heat is achieved not on account of the geodetic height differential, but with the aid of a compressor or a pump via compression work. In this case too, the greater the subcooling of the medium at the compressor inlet or the pump inlet, the denser the isobars in the T-s diagram or in the h-s diagram for CO₂, meaning that lower compression work is needed as the pressure increases.

FIG. 3 shows various variants a), b), c) and d) of the cooling apparatus for cooling of the liquid flow medium.

In the variant according to a), the cooling unit 7, the condenser 4 and a further cooling unit 16 are disposed in an aggregate, i.e. in a housing 17. The further cooling unit 16 is designed to cool the gaseous flow medium further before it enters the condenser 4. Therefore, the further cooling unit 16 is disposed upstream of the condenser 4 (not shown in FIG. 2). The further cooling unit 16 and the cooling unit 7 are designed as heat exchangers.

At the inlet 18, the flow medium flows through the housing 17. Cooling water 19 flows through the housing 17 in cooling water pipes 20. The cold cooling water, in the flow direction, passes first through the cooling unit 7, then the condenser 4, and subsequently the further cooling unit 16, which can also be referred to as heat remover. Variant a) thus effectively constitutes a series connection. The condensate outflow is chosen such that there are sufficient heat exchanger tubes below the liquid level, such that the liquid flow medium is subcooled. In each of the three cooling sections, a crossflow is established. X=0 represents the boiling curve. The cooling unit 7 is formed in a countercurrent arrangement.

Variant b) is comparable with variant a) in that the cooling water is guided in series through the individual components (cooling unit 7, condenser 4 and further cooling unit 16). Variant b) differs from variant a) in that the components are disposed in separate aggregates or housings by the countercurrent principle.

Variant c) is comparable with variant a) in that the individual components (cooling unit 7, condenser 4 and further cooling unit 16) are disposed in an aggregate or a housing 17. Variant c) differs from variant a) in that the cooling medium flows through all three components in parallel. Therefore, different heating ranges of the substreams are possible. A crossflow is established in each of the three cooling sections. This can be converted into a countercurrent arrangement via suitable guiding devices.

Variant d) is comparable with variant b) in that the individual components (cooling unit 7, condenser 4 and further cooling unit 16) are disposed in separate aggregates or housings. Variant d) differs from variant b) in that the cooling medium flows through all three components in parallel. The cooling is effected by the countercurrent principle.

All variants a), b), c) and d) pursue the aim of reducing the temperature of the flow medium as close as possible to the temperature of the cooling medium.

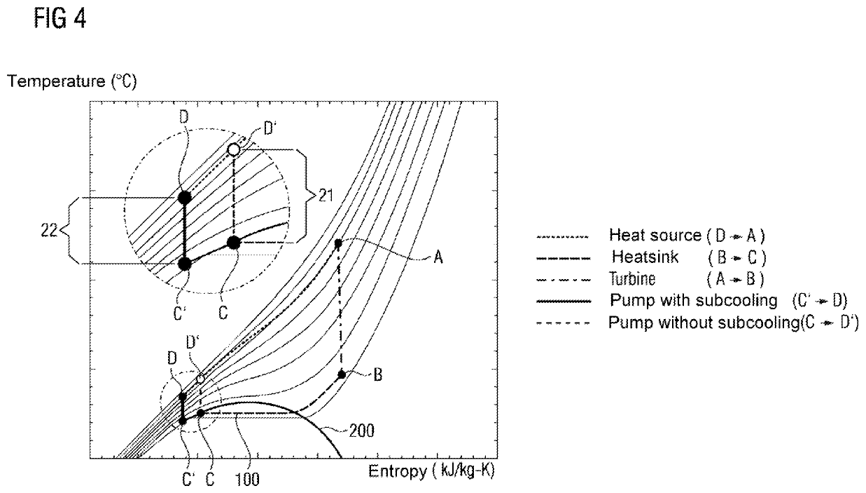

FIG. 4 shows a T-S diagram for the cycle of the invention, with the diagram showing a comparison with a conventional cycle.

The points A, B, C, C′, D shown in the diagram relate to the points shown in FIG. 2. For instance, point A is upstream of the entry of the flow medium into the steam turbine 6. Point B is beyond the steam turbine 6. Point C is beyond the condenser 4. Point C′ represents a situation where an inventive cooling unit 7 is disposed in the circuit. Point D is between the pump 3 and the generator 5.

Point A may be chosen as the starting point. From point A to point B, the flow medium is expanded in the steam turbine, while the temperature falls down to point B. From point B to point C, cooling of the gaseous flow medium takes place in the further cooling unit 16, followed by condensation in the condenser 4. The condensation is effected isothermally up to the point of intersection of lines 100 and 200. Without the inventive cooling unit 7, the cycle at point C would lead to point D (downstream of pump 3). With the inventive cooling unit 7, the temperature of the flow medium is lowered further along a corresponding isobar up to point C′. Proceeding from point C′, the pump 3 has to expend less pump output 22 than from point C to D′. The pump output 21 from point C to point D′ is greater than the pump output 22 from point C′ to point D.

The cooling from point C to point C′ increases the density of the flow medium and reduces its compressibility. Therefore, the pump outputs 21 and 22 are different.

Although the invention has been illustrated in detail and described by the working example, the invention is not restricted by the examples disclosed, and other variations may be derived therefrom by the person skilled in the art without leaving the scope of protection of the invention.

1. A system, comprising:
a pump for conveying a flow medium,
an arrangement for converting the flow medium from a liquid state to a gaseous state,
a flow machine for converting thermal energy of the flow medium to mechanical energy,
a condenser for condensing the gaseous flow medium to a liquid state, and
a cooling unit for cooling the liquid flow medium.

2. The system as claimed in claim 1,
wherein the cooling unit takes the form of a heat exchanger.

3. The system as claimed in claim 1,
wherein the condenser is connected to the pump for flow purposes and the cooling unit is disposed between the condenser and the pump.

4. The system as claimed in claim 1,
wherein the arrangement is a generator that converts carbon dioxide from the liquid state to the gaseous state by combustion of fuels.

5. The system as claimed in claim 1,
wherein the arrangement is a reservoir in a geodetic stratum, wherein geothermal energy converts carbon dioxide disposed in the reservoir from the liquid state to the gaseous state.

6. The system as claimed in claim 1,
wherein the flow machine is designed as a steam turbine or CO₂ expander.

7. The system as claimed in claim 1,
wherein the flow machine is connected to the condenser for flow purposes and a further cooling unit is disposed between the condenser and the flow machine, wherein the gaseous flow medium is cooled down in the further cooling unit.

8. The system as claimed in claim 7,
wherein the further cooling unit is designed as a heat exchanger.

9. The system as claimed in claim 1,
wherein the cooling unit, the condenser and the further cooling unit are disposed in a housing.

10. The system as claimed in claim 6,
wherein a cooling medium flows first through the cooling unit, then through the condenser and subsequently through the further cooling unit.

11. The system as claimed in claim 6,
wherein a cooling medium flows in parallel through the cooling unit, the condenser and the further cooling unit.

12. The system as claimed in claim 1,
wherein the cooling unit, the condenser and the further cooling unit are disposed in separate housings.

13. The system as claimed in claim 12,
wherein a cooling medium flows first through the cooling unit, then through the condenser and subsequently through the further cooling unit.

14. The system as claimed in claim 12,
wherein a cooling medium flows in parallel through the cooling unit, the condenser and the further cooling unit.

15. A method of operating a system designed as claimed in claim 1, comprising:
conveying a flow medium in the liquid state with a pump to an arrangement, wherein the flow medium is converted from a liquid state to a gaseous state in the arrangement,
guiding the gaseous flow medium into a flow machine, where the thermal energy of the flow medium is converted to mechanical energy,
converting, downstream of the flow machine, the flow medium back to the liquid state in a condenser,
reducing, downstream of the condenser, the temperature of the flow medium with a cooling unit before the flow medium is guided back to the pump.

16. The method as claimed in claim 15,
wherein the flow medium, before it flows into the condenser, is cooled in a further cooling unit.

17. The method as claimed in claim 15, further comprising:
guiding the flow medium, downstream of the pump, into a reservoir in the ground and heating by geothermal heat such that the flow medium undergoes a phase change from liquid to gaseous and then the gaseous flow medium is guided from the ground to flow machine.
